(19) United States
(12) Patent Application Publication
(10) Pub. No.: US 2015/0003090 A1
(43) Pub. Date: Jan. 1, 2015

(54) STRUCTURAL AND EFFECT-GENERATING FABRIC AS A LIGHT-SCATTERING ELEMENT IN OPTICAL SYSTEMS

(71) Applicant: Hella KGaA Hueck & Co., Lippstadt (DE)

(72) Inventor: Martin Mügge, Geseke (DE)

(73) Assignee: Hella KGaA Hueck & Co., Lippstadt (DE)

(21) Appl. No.: 14/167,771

(22) Filed: Jan. 29, 2014

(30) Foreign Application Priority Data
Feb. 1, 2013 (DE) 102013101021.0

(51) Int. Cl. F21V 1/16; F21V 13/02; F21V 1/02; F21S 8/10

(52) U.S. Cl. CPC F21V 1/16; F21S 48/00; F21V 13/02; F21V 1/02; F21Y 2101/00
USPC 362/510; 362/509

(57) ABSTRACT

A device for scattering light, especially for vehicles, includes at least one translucent material and at least one light unit for generating a lighting function, characterized in that the translucent material is a light-scattering textile fabric, wherein the fabric is arranged in the device or is positioned in front of the device and is designed so that the lighting function shines through the fabric.

### CROSS REFERENCE

This application claims priority to German Patent Application No. 10 2013 101021.0, filed Feb. 1, 2013.

### TECHNICAL FIELD OF THE INVENTION

The invention relates to a device for scattering light, especially for vehicles, having at least one translucent material and at least one light unit for generating a light function.

### BACKGROUND OF THE INVENTION

From the prior art, signal functions and lighting functions that are formed with LED technology in modern headlamps, rear lamps, interior lights, and general illumination lights are known.

From EP 650 010 A, an illumination device is known in the form of an elongated lamp with a light source that is used primarily for the backlighting of a liquid crystal display device. A disadvantage in the known illumination device is that complex light scattering is not possible.

From DE 102 40 270 A1, a trim element for the interior of a vehicle, especially a motor vehicle, is known. The trim element has a base part that is provided with a surface side with a transparent cover layer that faces the vehicle interior and is suitable for the emission of light. For this purpose, the cover layer has an elastically compressible construction. A disadvantage in the known trim element, however, is that it can produce only simple optical effects.

The problem of the present invention is therefore to disclose a device with which complex light scattering can be achieved.

Another problem of the invention is to disclose a device that is to be produced so that it uses little space and is simple and economical and can generate a lighting function that produces distinct patterns, different colorings, and also three-dimensional illuminating elements, so that stylistic elements can be produced in lighting functions.

### SUMMARY OF THE INVENTION

To solve this problem, a translucent material is a light-scattering, textile fabric, wherein the fabric is arranged in the device or is positioned in front of the device and is designed so that the lighting function shines through the fabric.

The special advantage of the invention consists in that a device for scattering light is provided that has an effect-generating or light-emitting fabric that can be used as a light scattering element and simultaneously as a stylistic element.

According to one refinement of the invention, the fabric has a color-producing fabric structure. For this purpose, the fabric can be realized in different color designs, so that, in its cold appearance, a lighting function that is covered by such a fabric is given a colored, textile character. In its warm appearance, an illumination or an illumination pattern with scattering of the light is produced behind the fabric by the type of the fabric (structure, direction of weaving, elements woven into the fabric) and the design of the optical system.

According to one refinement of the invention, LED light sources or incandescent lamps or optical systems are provided for illuminating the fabric.

In addition to the point-shaped LED spots, the light scattering can be achieved by linear or curve-like scattering areas that generate a distinct pattern. If the direction of observation is not directly from the front, then the lines of illumination appear to be curved, even though the fabric is positioned flat in front of the LED. In this way, a constantly changing illumination view of the function is given to the viewer.

At the same time, the point-shaped light source is visibly increased, wherein the illuminating signal surface area is increased despite the use of smaller LED light sources and delivers a striking and large area appearance to a viewer. The best illumination effects are achieved with point-shaped light sources.

According to one refinement of the invention, in addition to LED light sources or incandescent lamps, also optical systems are used, e.g., lenses or reflectors, whose light distribution can be traced back to a theoretical point. In this way, the best illumination effects can be achieved.

For a lens with divergent scattering, the virtual focal point of the light source is behind the lens.

According to one refinement of the invention, if a reflector is used with a direct light source, multiple virtual focal points are produced that are imaged onto the textile fabric.

The selection and design of the optical system behind the fabric thus defines not only the light distribution but also, in the interaction with the structure of the fabric, the illumination or the illumination pattern on the fabric visible for a viewer.

The number and type of LEDs can be freely selected for each desired design. Standard LEDs, high-power LEDs, or multi-chip LEDs can be used. A lighting function can also be formed with incandescent lamps, such as with miniature incandescent lamps.

Preferably, an incandescent lamp can be used with a large reflector that reflects the light in a convergent pattern, so that the reflected light at each optical surface passes through an opening in a screen in front of the reflector. A corresponding number of light spots and scatter lines are then imaged on the fabric positioned in front of the screen analogous to the number of light openings in the screen.

Optical fiber optics can also be used, in order to receive the light from the LEDs and to output the light behind the fabric.

If the functional space behind the fabric with the optical system positioned there or the screen arranged in-between has a dark design, a functional surface can be generated. For a colored fabric (blue, red, etc.), the optical functional space or the screen behind the fabric can be colored accordingly.

The basic configuration of a lighting function with a textile scattering fabric consists of an optical system that could also be just a printed circuit board with an LED, an optional screen, and the fabric that is positioned in front of the screen and is enclosed and held in a holder element.

According to one refinement of the invention, at least one holder frame can be provided in order to hold the textile fabric. The holder frame can be made from a front element and a rear element, with the fabric being held between these elements. Alternatively, only one holder element on which the fabric is held could also be provided.

According to one refinement of the invention, the holder frame could be designed to hold the fabric or also two or more different fabrics one in front of the other, so that an overlapping light scattering pattern is produced. In particular, if the thread directions of the fabric are oriented in different directions, additional light scattering is produced.

According to one refinement of the invention, the fabric could be inserted into an injection molding tool and enclosed like a frame or bonded onto the holder element or attached by means of a hook-and-loop fastener or fixed by screws or bolts or rivets.

According to one preferred embodiment of the invention, the three-dimensional hollow space is filled with a fabric ball and this area is illuminated by an optical system lying behind the area. Thus, complex light scattering is achieved and simultaneously a three-dimensional illuminating element is realized.

The fabric can be positioned, in particular, in a planar arrangement in front of the optical system or the light sources or can also run in a curved shape (concave or convex) or at an angle relative to the optical system, so that different distances of the individual light sources to the fabric are realized.

The holder frame can also be constructed as a transparent, clear glass pane on which the fabric is attached flat, for example, sprayed on.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a schematic diagram of an arrangement of a textile fabric for use as a light-scattering element between two holder frames before the assembly into one unit,

FIG. 2 a schematic diagram of the textile fabric from FIG. 1 after the assembly into one unit,

FIG. 3 a schematic diagram of an alternative arrangement of a textile fabric for use as a light-scattering element between two holder frames before the assembly into one unit,

FIG. 4 a schematic diagram of the textile fabric from FIG. 3 after the assembly into one unit,

FIG. 5 a schematic diagram of another alternative arrangement of a textile fabric for use as a light-scattering element between two holder frames before the assembly into one unit, and

FIG. 6 a schematic diagram of the textile fabric from FIG. 5 after the assembly into one unit.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

A textile fabric according to the invention for use as a light-scattering element can be integrated in front of or in an optical system in a rear tail lamp, a headlamp, or general illumination lights.

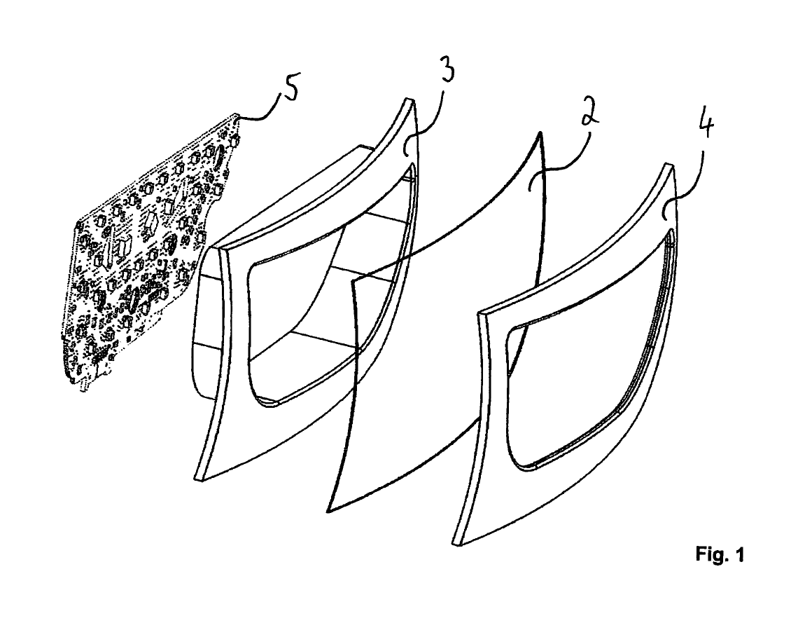

FIG. 1 shows a schematic diagram of an arrangement of a textile fabric for use as a light-scattering element between two holder frames before the assembly into one unit.

In addition to the textile fabric 2, FIG. 1 shows the two holder frames 3 and 4 and an optical system made from an LED printed circuit board 5. The first holder frame 2 is the frame of an illumination device. The second holder frame 4 is an additional cover frame. The textile fabric 2 and the two holder frames 3 and 4 each have convex geometry.

The textile fabric 2 is then placed on the first holder frame 3. The second holder frame 4 is then placed on the textile fabric 2. The LED printed circuit board 5 is attached on the first holder frame 3.

Thus, the textile fabric 2 is located between the first holder frame 3 with the LED printed circuit board 5 and the second holder frame 4.

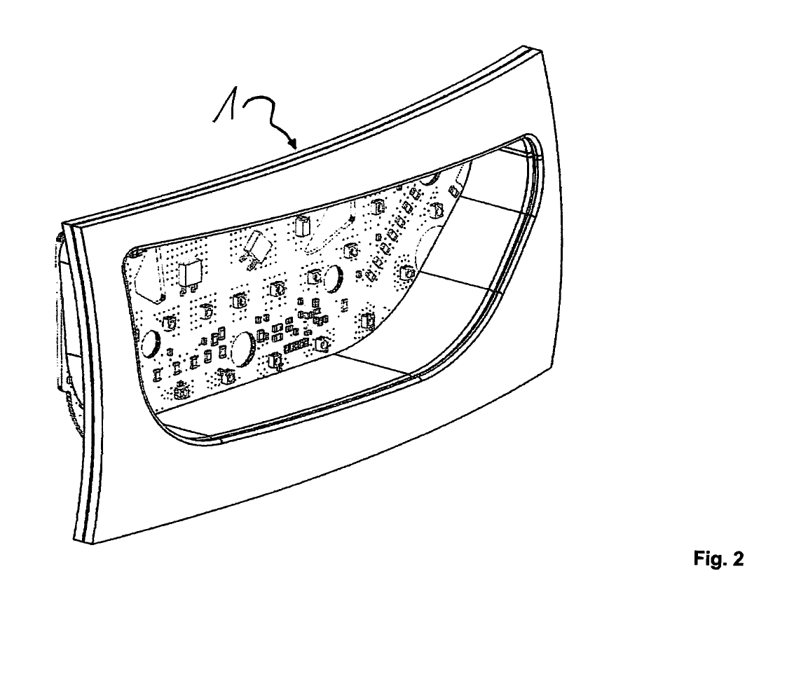

FIG. 2 shows a schematic diagram of the textile fabric from FIG. 1 after the assembly into one unit.

The textile fabric 2 is positioned and fixed after the assembly between the first holder frame 3 and the second holder frame 4. The textile fabric 1 and the two holder frames 3 and 4 also have convex geometry. The individual components form the device for scattering light 1.

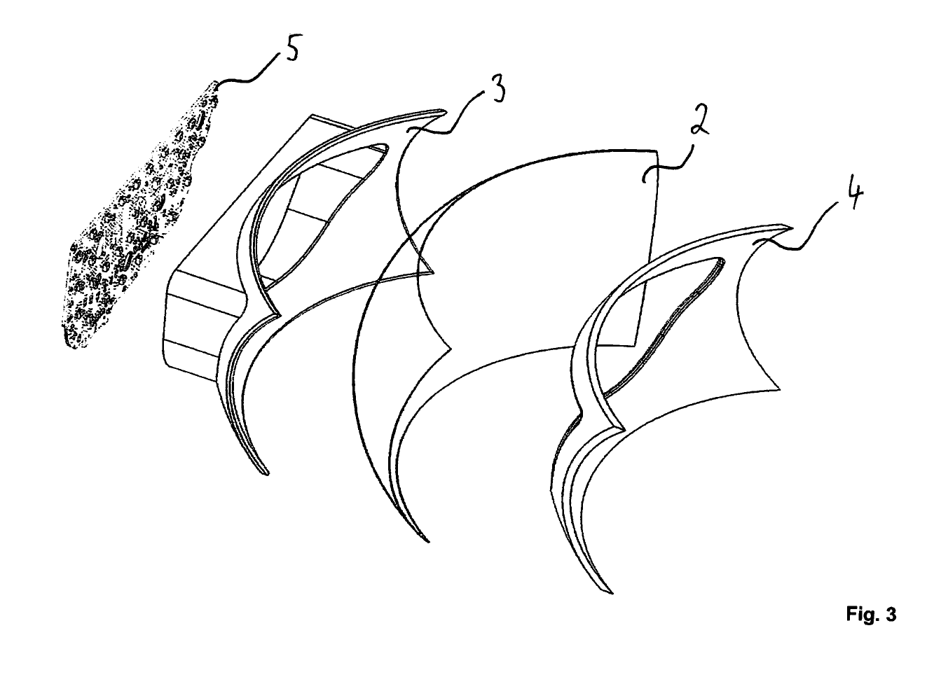

FIG. 3 shows a schematic diagram of an alternative arrangement of a textile fabric for use as a light-scattering element between two holder frames before the assembly into one unit.

In addition to the textile fabric 2, FIG. 1 shows the two holder frames 3 and 4 and an LED printed circuit board 4. The first holder frame 3 is the frame of an illumination device. The second holder frame is an additional cover frame 4. The textile fabric 2 and the two holder frames 3 and 4 each have concave geometry.

The textile fabric 2 is then placed on the first holder frame 3. The second holder frame 4 is then placed on the textile fabric 2. The LED printed circuit board 5 is attached on the first holder frame 3.

Thus, the textile fabric 2 is located between the first holder frame 2 with the LED printed circuit board 5 and the second holder frame 4.

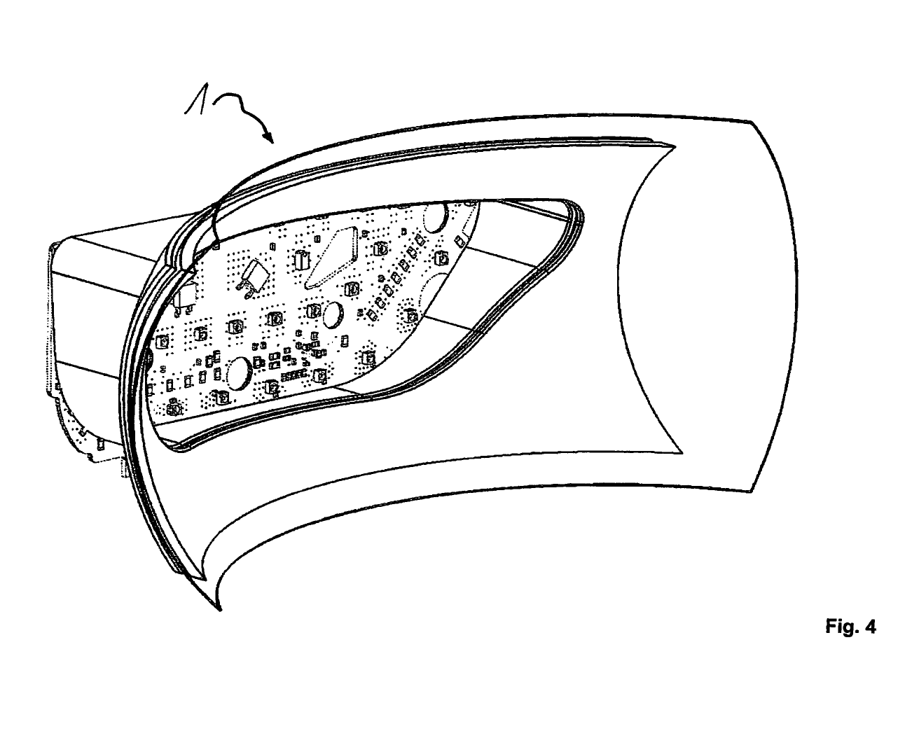

FIG. 4 shows a schematic diagram of the textile fabric from FIG. 3 after the assembly into one unit.

The textile fabric 2 is positioned and fixed after the assembly between the first holder frame 3 and the second holder frame 4. The textile fabric 2 and the two holder frames 3 and 4 also have concave geometry. In this way, the fabric 2 projects from the unit on all sides. The individual components form the device for scattering light 1.

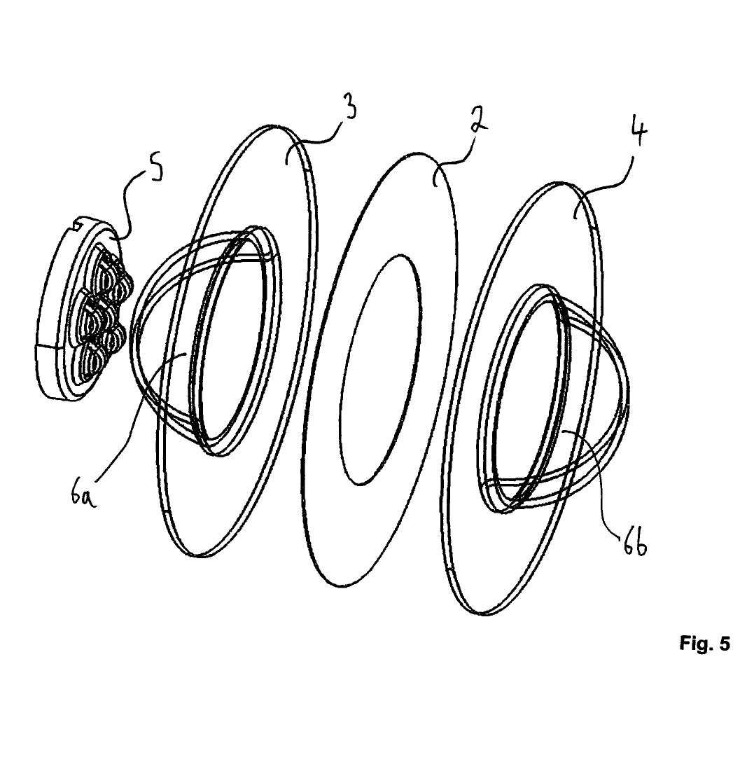

FIG. 5 shows a schematic diagram of another alternative arrangement of a textile fabric for use as a light-scattering element between two holder frames before the assembly into one unit.

In addition to the textile fabric 2, FIG. 1 shows the two holder frames 3 and 4 and an LED printed circuit board 5. The configuration from FIG. 5 provides a two-part frame consisting of two transparent holder frames 3 and 4. The two holder frames 3 and 4 each have a hollow space 6a and 6b, respectively, which are domed in the middle toward the outside.

The textile fabric 2 and the two holder frames 3 and 4 each have flat/planar and ring-shaped geometry of the contact surfaces.

The textile fabric 2 is then placed on the first holder frame 3. The second holder frame 4 is then placed on the textile fabric 2. Here, the LED printed circuit board 5 attaches behind the first holder frame 3.

Thus, the textile fabric 2 is located between the first holder frame 3 and the second holder frame 4.

In addition, a fabric that is not flat but instead is constructed as a fabric ball or fabric cone (crumpled together) can then also be inserted between the two hollow spaces 6a and 6b.

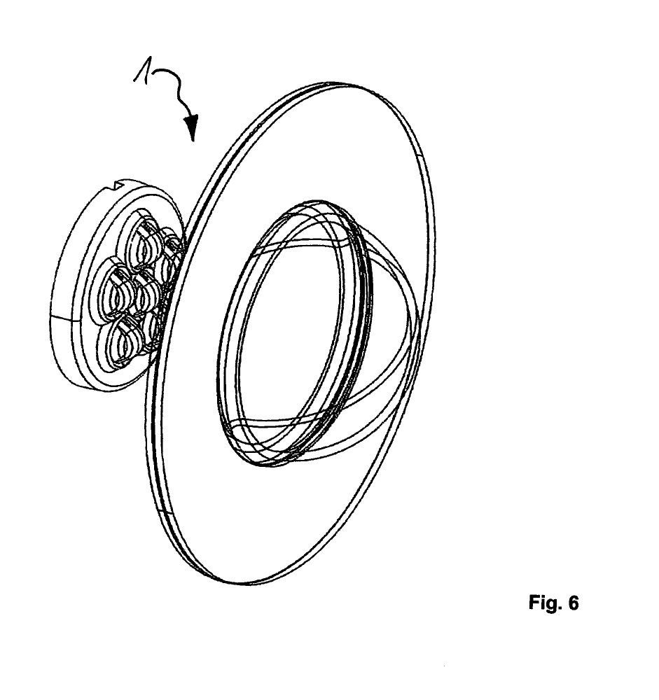

FIG. 6 shows a schematic diagram of the textile fabric from FIG. 5 after the assembly into one unit.

The textile fabric 2 is positioned and fixed after the assembly between the first holder frame 3 and the second holder frame 4. The individual components form the device for scattering light 1.

If the three-dimensional hollow space is also equipped with a fabric ball and if the unit is illuminated by an optical system lying behind the unit, then complex light scattering is realized and simultaneously a three-dimensional illuminating element is created.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SYMBOLS

1 Device for scattering light

2 Textile fabric

3 First holder frame

4 Second holder frame

5 Optical system

6a, 6b Hollow space

1. A device for scattering light, especially for vehicles, comprising:
at least one translucent material and at least one light unit for generating a lighting function, wherein the translucent material is a light-scattering textile fabric, wherein the fabric is arranged in the device or is positioned in front of the device and is designed so that the lighting function shines through the fabric.

2. The device for scattering light according to claim 1, wherein the textile fabric has a fabric structure producing a color.

3. The device for scattering light according to claim 1, wherein the textile fabric has elements that are woven into the fabric.

4. The device for scattering light according to claim 1, further comprising point-shaped light sources, such as LED light sources or incandescent lamps or optical systems for shining light onto the textile fabric.

5. The device for scattering light according to claim 4, wherein lenses or reflectors whose light distribution can be traced back to a single theoretical point are used as the optical systems.

6. The device for scattering light according to claim 5, wherein when a reflector with a direct light source is used, several virtual focal points are produced that are imaged onto the textile fabric.

7. The device for scattering light according to claim 1, wherein at least one holder frame is provided in order to hold the textile fabric.

8. The device for scattering light according to claim 7, wherein the holder frame is designed to hold the fabric or also two or more different fabrics one in front of the other.

9. The device for scattering light according to claim 1, wherein the fabric is designed to be inserted into an injection molding tool.

10. The device for scattering light according to one of claim 1, wherein the fabric has the shape of a fabric cone or a fabric ball.

11. The device for scattering light according to claim 3, wherein the elements woven into the fabric are metallic fibers.

12. The device for scattering light according to claim 7, wherein the fabric is designed to be to be bonded onto the holder frame.

13. The device for scattering light according to claim 7, wherein the fabric is designed to be to be fixed on the holder frame by means of a hook-and-loop fastener or by screws or bolts and rivets.
